(19) United States
(12) Patent Application Publication
(10) Pub. No.: US 2024/0351282 A1
(43) Pub. Date: Oct. 24, 2024

(54) Rotational Stereolithography for Arcuate 3D Articles

(71) Applicant: 3D Systems, Inc., Rock Hill, SC (US)

(72) Inventor: Colin Leonard Blain, Hertfordshire (GB)

(21) Appl. No.: 18/636,353

(22) Filed: Apr. 16, 2024

Related U.S. Application Data
(60) Provisional application No. 63/496,752, filed on Apr. 18, 2023.

(51) Int. Cl. B29C 64/241; B29C 64/106; B29C 64/171; B29C 64/245; B29C 64/264; B29C 64/386; B29L 31/00; B33Y 10/00; B33Y 30/00; B33Y 50/00; B33Y 80/00

(52) U.S. Cl. CPC B29C 64/241; B29C 64/106; B29C 64/171; B29C 64/245; B29C 64/264; B29C 64/386; B29L 2031/7536; B33Y 10/00; B33Y 30/00; B33Y 50/00; B33Y 80/00

(57) ABSTRACT

A three-dimensional (3D) printing system is configured to manufacture a plurality of arcuate 3D articles. The 3D printing system includes a build vessel, at least one build assembly, a light engine, and a controller. The at least one build assembly individually includes an axle, a build plate, and a motorized gear assembly. The motorized gear assembly is coupled to the axle and configured to rotationally position the axle about an axis of rotation. The light engine is located above the build vessel. The controller is configured to operate the motorized gear assembly to incrementally rotate the build plates about the axis of rotation between a plurality of stop positions. The controller is configured to operate the light engine at individual stop positions to selectively irradiate the photocurable liquid within a plurality of spatially separated build planes that are individually above one of the plurality of build plates.

### CROSS-REFERENCE TO RELATED APPLICATIONS

This non-provisional patent application claims priority to U.S. Provisional Application Ser. No. 63/496,752, Entitled “Rotational Stereolithography for Arcuate 3D Articles” by Colin Leonard Blain, filed on Apr. 18, 2023, incorporated herein by reference under the benefit of U.S.C. 119 (e).

### FIELD OF THE INVENTION

The present disclosure concerns an apparatus and method for manufacturing three-dimensional (3D) articles from photocurable liquids in a layer-by-layer manner. More particularly, the present disclosure concerns a way of simultaneously manufacturing a plurality of customized arcuate-shaped articles using a relatively compact and simple apparatus.

### BACKGROUND

Three dimensional (3D) printers are in rapidly increasing use for manufacturing customized 3D articles. One class of 3D printers includes stereolithography printers having a general principle of operation including the selective curing and hardening of radiation curable (i.e., photocurable) liquids. The 3D articles are formed in a layer-by-layer manner. One substantial application of this technology is the fabrication of customized arcuate objects such as dental arches and retainers. There is a desire to improve productivity for this type of application.

### SUMMARY

In a first aspect of the disclosure, a three-dimensional (3D) printing system is configured to manufacture a plurality of arcuate 3D articles. By “arcuate”, the 3D articles can have an arcuate geometry such as a circular, elliptical, or arch geometry or shape. The arcuate geometry can have a degree of asymmetry or irregularity. One example of an arch shape is a dental arch. The 3D printing system includes a build vessel, at least one build assembly, a light engine, and a controller. The build vessel is configured to contain a photocurable liquid having an upper liquid surface. The at least one build assembly individually includes an axle, a build plate, and a rotational movement mechanism. The axle has a horizontal axis of rotation X. The build plate is attached to the axle and extends radially from the axle. The build plate has an upper surface. The rotational movement mechanism is coupled to the axle and configured to rotationally position the axle about the axis of rotation X. The light engine is located above the build vessel. The controller is configured to operate the rotational movement mechanism to incrementally rotate the build plate about the axis of rotation between stop positions. During the individual stop positions, the controller is configured to operate the light engine to selectively irradiate the photocurable liquid within a plurality of spatially separated build planes to selectively harden a slice of an arcuate 3D article of the plurality of arcuate 3D articles.

Arcuate objects, particularly dental arches, represent a major application of 3D printing. Relative to prior systems, this apparatus is very compact and volumetrically efficient. Having a smaller system providing the same functionality is advantageous in dental labs where physical space is costly. In addition, photocurable resin is quite costly and has a limited life once placed into a production vat. A smaller volume requirement therefore reduces an operating cost.

In one implementation, the at least one build assembly includes a plurality of the build assemblies arranged along a lateral axis Y that is perpendicular to the axis of rotation X. The plurality of build assemblies individually span most or all of the width of the build vessel along the X axis.

In another implementation, the build plates individually extend along a radial axis r from the axis of rotation X. Individual slices of the arcuate 3D article have a trapezoidal cross section having two parallel bases having a base dimensions proportional to their radial positions.

In various implementations, a slice thickness can vary from 0.05 millimeter (mm) to 0.2 mm or from 0.1 mm to 0.2 mm. Yet other thickness ranges are possible.

In yet another implementation, a method of fabricating a plurality of arcuate 3D articles includes rotatively positioning the plurality of build plates individually having an upper face of an arcuate 3D article a layer thickness below the upper surface of the photocurable liquid, and operating the light engine to selectively irradiate a plurality of spatially separated build planes individually aligned with the upper face of the arcuate 3D article to cure and harden a slice of the photocurable liquid onto the upper face of the arcuate 3D article. The slice of the photocurable liquid has a variable thickness that is proportional to a distance from the axis of rotation X.

In a second aspect of the disclosure, a method of manufacturing an arcuate three-dimensional (3D) article includes the following steps: (1) Providing a 3D solid model of the arcuate 3D article. (2) Slicing the 3D solid model with a set of slicing planes that diverge from an axial region or axis below an apex of the arcuate 3D model. (3) Rotatively moving an upper face of a build plate or a partially finished portion of the arcuate article about the locus and provide a layer of photocurable liquid above the upper face. (4) Operating a light engine to selectively cure the layer of photocurable liquid onto the upper face to form a new upper face. (5) Repeating the rotatively moving and operating the light engine to complete fabrication of the arcuate 3D article from a series of variable thickness slices, the slices individually have an increasing thickness versus distance from the axial region.

In one implementation the arcuate 3D article includes a dental arch. The arcuate 3D article can also include a support structure configured to couple one end of the dental arch to the upper face of the build plate.

In another implementation the slicing planes diverge from an axis located below the apex of the 3D model. The axis can be an axis of rotation of the build plate. The slicing includes forming a stack of slices that have a thickness proportional to a radial distance from the axis.

In a third aspect of the disclosure, a method of manufacturing a plurality of arcuate three-dimensional articles includes the following steps (1)-(4). Step (1) is providing a 3D printing system including a build vessel, a build assembly, and a light engine. The build vessel is configured to contain a photocurable liquid having an upper surface. The build assembly includes an axle having a horizontal axis of rotation X, a build plate attached to the axle extending radially from the axle and having an upper surface, and a rotational movement mechanism coupled to the axle configured to rotationally position the axle about the axis of rotation X. The light engine is above the build vessel. Step (2) includes operating the rotational movement mechanism to position an upper face of individual ones of the plurality of arcuate 3D articles to a position that is a layer thickness below the upper surface of the photocurable liquid. The layer thickness varies varying linearly along a radius extending from an axis of rotation of the axle. Step (3) includes operating the light engine to selectively irradiate a plurality of build planes corresponding individually to the plurality of arcuate three-dimensional (3D) articles and hardening a trapezoidal slice of the photocurable liquid upon the upper face. Step (4) includes repeating steps (2) and (3) to complete fabrication of the plurality of arcuate three-dimensional articles.

### BRIEF DESCRIPTION OF THE FIGURES

FIG. 1 is a schematic side (Y, Z axes are horizontal and vertical respectively) cutaway diagram of an embodiment of a 3D printing system.

FIGS. 2A and 2B are schematic plans or top views (X, Y are orthogonal horizontal axes) of an embodiment of a 3D printing system.

FIG. 3 is a flowchart depicting an embodiment of a method for manufacturing a plurality of arcuate 3D articles.

FIG. 4A is a schematic side view of a single build platform rigidly attached to an axle to allow the axle to rotatively tilt the build platform. This illustrates an initial state before a layer or slice of photocurable liquid is cured onto the build platform.

FIG. 4B differs from FIG. 4A in that a first layer or slice of photocurable liquid has been selectively cured onto the build platform.

FIG. 4C differs from FIG. 4B in that a second layer or slice of photocurable liquid has been selectively cured onto the first layer or slice of hardened photocurable liquid. The second slice has a trapezoidal shape because it is cured when the top surface of the first slice is tilted at an oblique angle into the photocurable liquid.

FIG. 4D differs from FIG. 4C in that a third layer or slice of photocurable liquid has been selectively cured onto the second layer or slice of hardened photocurable liquid.

FIG. 5 is a flowchart depicting an embodiment of a method of manufacturing an arcuate 3D article.

FIG. 6A illustrates slicing of an arcuate 3D article with a diverging set of slicing planes.

FIG. 6B illustrates solidification of a first slice of an arcuate 3D article.

FIG. 6C illustrates solidification of a second slice of an arcuate 3D article.

FIG. 6D illustrates ongoing progression of solidifying an arcuate 3D article.

FIG. 7 depicts dental arches and supports as an example of an arcuate 3D article.

FIG. 8 is a schematic diagram illustrating another embodiment of an arcuate 3D article relative to an axis of rotation.

### DETAILED DESCRIPTION OF THE PREFERRED EMBODIMENTS

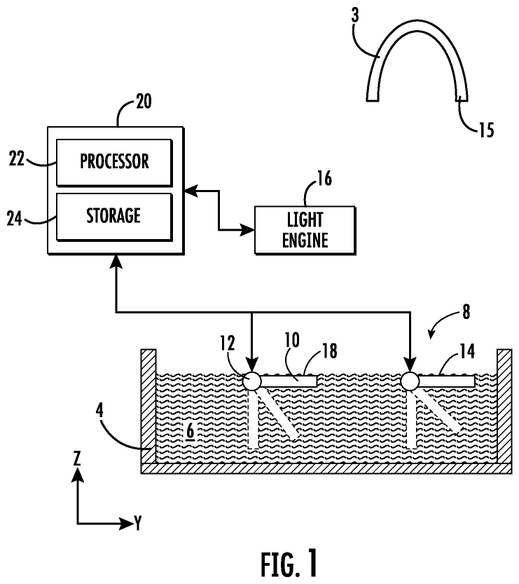

FIG. 1 is a schematic side cutaway diagram of a 3D printing system 2 for fabricating a plurality of customized arcuate 3D articles 3 individually having a arcuate geometry. In the context of the present disclosure, arcuate can be indicative of semicircular, elliptical, hyperbolic, parabolic, or arch-shaped geometry. In some cases, the arcuate geometry can be asymmetrical or irregular to some extent. In describing the 3D printing system mutually perpendicular axes X, Y, Z can be used. The X and Y axes are lateral axes that are generally horizontal. The Z axis is a vertical axis that is generally aligned with a gravitational reference. In using the word “generally” it is implied that a quantity or property is by design but may not be exact.

3D printing system 2 includes a build vessel 4 configured to contain a photocurable liquid 6. The photocurable liquid 6 can be cured and hardened with radiation in blue to ultraviolet wavelengths or about 500 nm (nanometers) to 100 nm. The photocurable liquid 6 can be a photocurable resin which can include various components including a monomer and photoinitiator or catalyst. Exposure to radiation with a suitable wavelength in the blue to ultraviolet wavelength will cause the photoinitiator or catalyst to initiate polymerization and/or cross-linking of the monomer to form a solid. Photocurable liquids and resins are known in the art for stereolithography.

Mounted to the build vessel 4 is at least one build assembly 8. A build assembly 8 includes at least one build plate 10 coupled to a (motorized) axle 12. The build plate 10 has a build surface 14 upon which one end 15 of the 3D article 3 is formed. During formation of 3D article 3, the axle 12 rotates the build plate through the photocurable liquid 6. Different orientations of the build plate 10 during formation of 3D article 3 are indicated by dashed lines in FIG. 1.

In an illustrated embodiment, a plurality of the axles 12 individually position a plurality of the build plates 10. At an initial position, a thin layer of the photocurable liquid 6 resides above the build surface 14 over a build plane 18. Thus, the illustrated embodiment includes a two dimensional array or plurality of the build planes 18. The build planes 18 may “move around laterally” as fabrication progresses for the arcuate 3D article 3.

Light engine 16 is configured to selectively deliver radiation to the array of build planes 18 to selectively cure and harden the thin layer of the photocurable resin 6. In a first embodiment, the light engine 16 includes a laser, a scanner, and projection optics. The scanner is a two dimensional scanner such as a series of galvanometer mirrors including an X-mirror and a Y-mirror. A beam of light from the laser passes through the scanner and is focused by the projection optics at the array of build planes 18. The X and Y mirrors laterally scan the beam over the build planes 18 along the X and Y axes respectively. Light engines according to a first embodiment are known in the art for stereolithography.

In a second embodiment, the light engine 16 includes a light source, a micromirror array, and projection optics. The light source illuminates the micromirror array. The micromirror array has a two dimensional array of micromechanical mirrors that can be individually switched between transmitting a pixel beam of light through the projection optics to a build plane 18 or to a “light trap” that absorbs the light. The result is a selective projection of radiation pixels over the build plane 18. Light engines according to the second embodiment are also known in the art for stereolithography.

In a third embodiment, the light engine 16 can include a “light bar” that scans over a build plane. The light bar can include an array of light emitting devices that are in “on” and “off” states during the scanning to selectively irradiate pixels of the build plane. Yet other light engine 16 embodiments are possible such as those employing various components such as rotating polygon mirrors as scanning devices.

A controller 20 is coupled to the motorized axles 12 and light engine 16. The controller 20 includes a processor 22 coupled to an information storage device 24. The information storage device 24 includes a non-volatile or non-transient storage medium storing software instructions. The non-volatile or non-transient storage medium can include one or more of a magnetic disc drive and flash memory. When executed by the processor 22, the software instructions can operate motors to rotate axles 12 and can operate light engine 16.

The controller 20 can be a single computer controller co-located with other components of 3D printing system 2. Alternatively, the controller 20 can include multiple computer controllers that can be co-located, separated from, or remote from the other components of system 2. As such, the controller 20 can include one or more of a microcontroller, a desktop computer, a laptop computer, a computer server, or other computing devices known in the art of computer science and engineering.

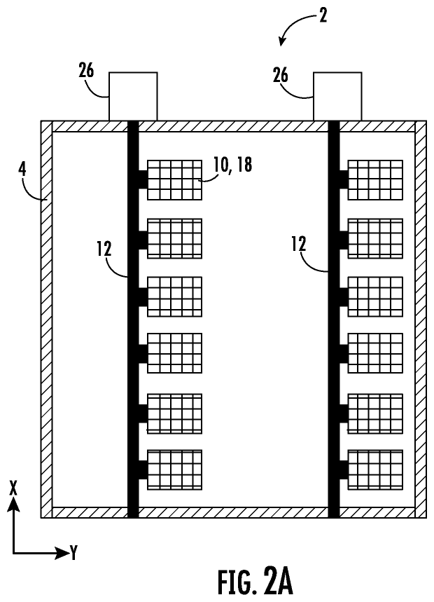

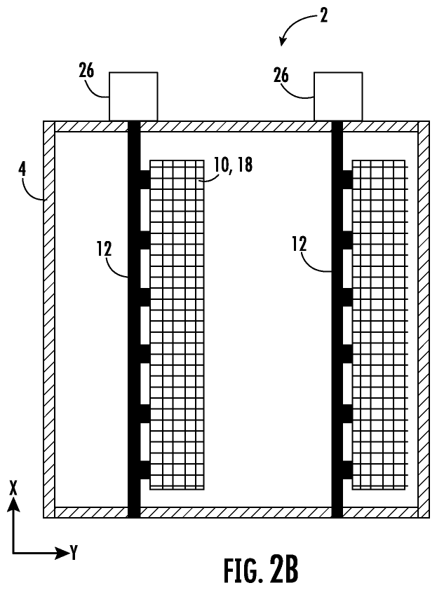

FIG. 2A is a schematic plan view of the 3D printing system 2. In the illustrated embodiment, two axles 12 individually support six of the build plates 10 for a total of 12 build plates 10. The illustrated configuration allows twelve (or possibly more) customized arcuate 3D articles 3 to be manufactured simultaneously. In the illustrated embodiment, the light engine 16 is configured to image the two dimensional array of 12 build planes 18 that individually correspond to the individual build plates 10. The axles 12 are individually coupled to a rotational movement mechanism 26. The rotational movement mechanism can be a motorized gear assembly 26.

It is to be understood that the illustrated number of two axles 12 individually having six build plates 10 is one of many possible configurations. In other embodiments, one axle 12 may support 2 or more build plates. An axle 12 may support and rotatively position 3, 4, 5, 6, 7, 8, 9, 10, or more build plates 10. The number of axles can be 3, 4, 5, 6, 7, or more axles 12.

In the illustrated embodiment, the motorized gear assembly 26 includes a stepper motor coupled to a “gear train”. The gear train is a series of gears configured to achieve an appropriate gear reduction between the stepper motor and the axle 12. Such motor and gear assemblies are known in the art for very accurate rotational positioning control. Other motors such as servo motors can also be considered. Such motors and gear trains for incremental motion control (motion in rotational steps) are known in the art for various applications such as in the printing industry.

FIG. 2B is similar to FIG. 2A except that a single build plate 10 extends along and from the axle 12. Otherwise, elements of FIG. 2B are the same in function and construction as elements in FIG. 2A. The light engine 16 can define a plurality or linear array of laterally spaced build planes 18 upon a build plate 10.

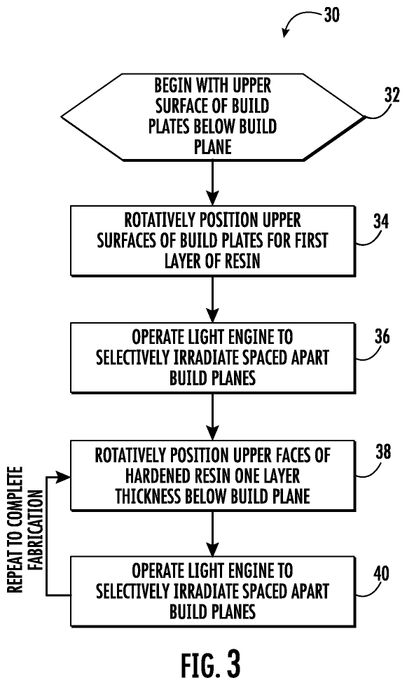

FIG. 3 is a flowchart depicting a method 30 of manufacturing a plurality of arcuate 3D articles 3. Method 30 is performed by controller 20 acting upon the motorized gear assemblies 26 and the light engine 16. According to 32, the axles 12 are rotationally positioned such that the build plates 10 are below the upper surface or build plane 18 of the photocurable liquid 6. The upper surface 14 of build plates 10 are thus immersed in the photocurable liquid 6.

According to 34, the axles 12 are rotated such that a layer thickness of the photocurable liquid 6 and build plane 18 are above the upper surfaces 14. According to 36, the light engine 16 is activated to selectively irradiate the array of build planes 18 and to selectively cure and harden a layer thickness of the photocurable liquid 6 onto the upper surfaces 14. The hardened photocurable liquid or resin 6 defines an upper face of a slice of the arcuate 3D article 3.

According to 38, the axles rotatively position the upper faces of hardened resin 6 one layer thickness below the build planes 18. In an illustrative embodiment, the positioning of step 38 includes a “deep dip” movement in which the axles 12 rotate the upper faces 14 more than a layer thickness below the build plane 18 and then back up to one layer thickness below the build plane 18.

Step 40 is similar to step 36. Steps 38 and 40 are repeated to fabricate the arcuate 3D article 3 layer by layer to completion.

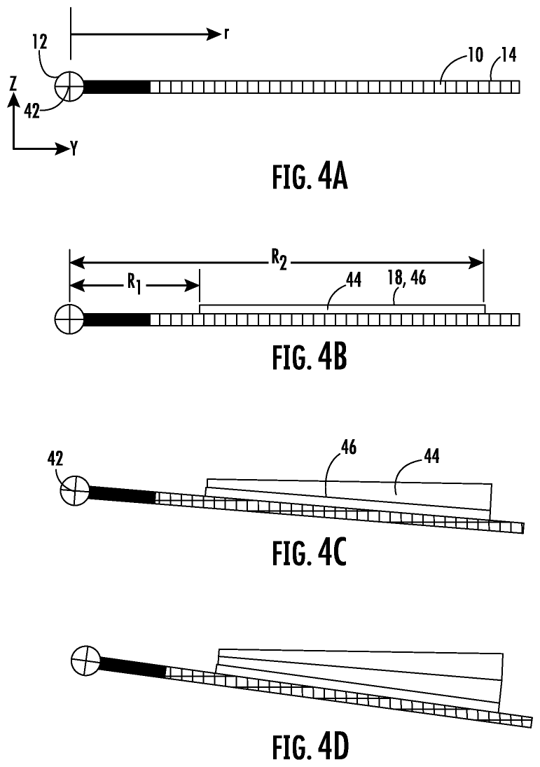

FIGS. 4A-D illustrate the fabrication of layers or slices of the arcuate 3D article 3. FIG. 4A illustrates the build plate 10 coupled to axle 12 before slices or layers of the photocurable liquid 6 are hardened upon upper surface 14. The axle 12 has an axis of rotation 42 which is parallel to the X-axis (FIG. 2). A radial distance r is defined as a distance along the build plate 10 from the axis of rotation 42. An angle of rotation from horizontal can be defined as an angle theta (Θ).

FIG. 4B illustrates a hardened slice of 44 of photocurable liquid on the build plate. The slice has a thickness along Z and is laterally bounded by r values of R1 and R2. FIG. 4B illustrates a result of steps 34 and 36. The first and subsequent hardened slices 44 individually has an upper face 46.

FIG. 4C illustrates steps 38 and 40 forming a second hardened slice 44. The photocurable liquid 6 has an increasing depth along radius r, so that the hardened slice 48 has a trapezoidal shaped cross section. The base at r=R2 (farther from the axis of rotation 42) is larger than the base at r=R1 (closer to the axis of rotation). At any point along the build plate 10, the slice thickness is approximately equal to the radius r times a change in the angle theta (θ) from FIG. 4B to 4C. Thus, the base at r=R1 has a height of about R1 times the change in the angle theta (θ). The base at r=R2 has a height of about R2 times the change in the angle theta (θ). This will be generally true for each subsequent hardened slice 44. FIG. 4D illustrates a third hardened slice.

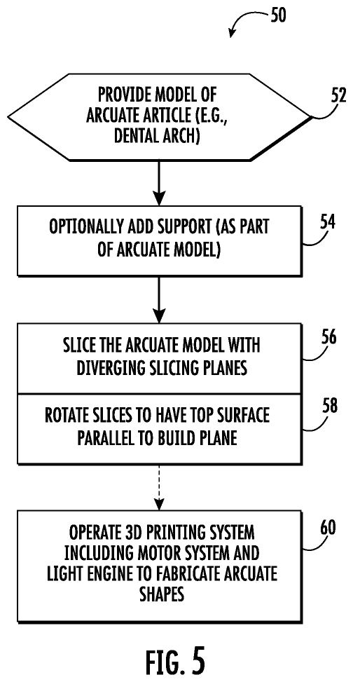

FIG. 5 is a flowchart depicting an embodiment of a method 50 of manufacturing an arcuate 3D article 3. Relative to the method 30 described with respect to FIG. 3, method 50 puts more emphasis on slicing. According to 52, a three-dimensional (3D) solid model of an arcuate 3D article 3 is provided. The 3D solid model can be tantamount to a computer aided design (CAD) file. One example of such an arcuate 3D article 3 is a dental arch. Optionally according to 54, a support is added to one end of the arcuate 3D model 3 for coupling to the build plate 10.

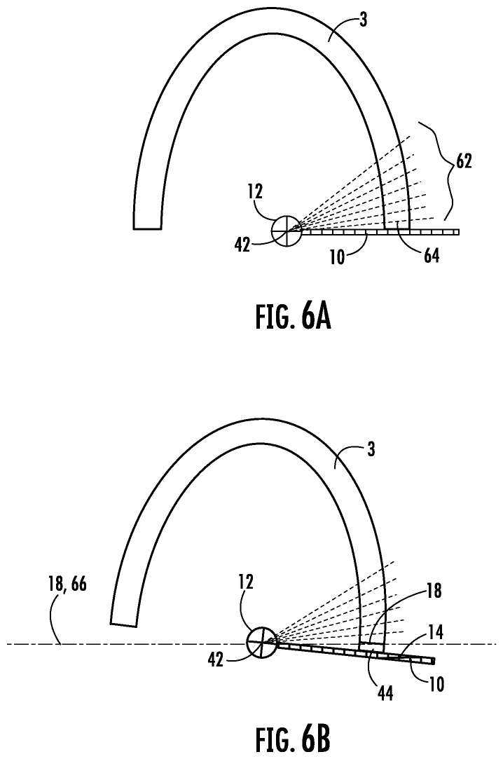

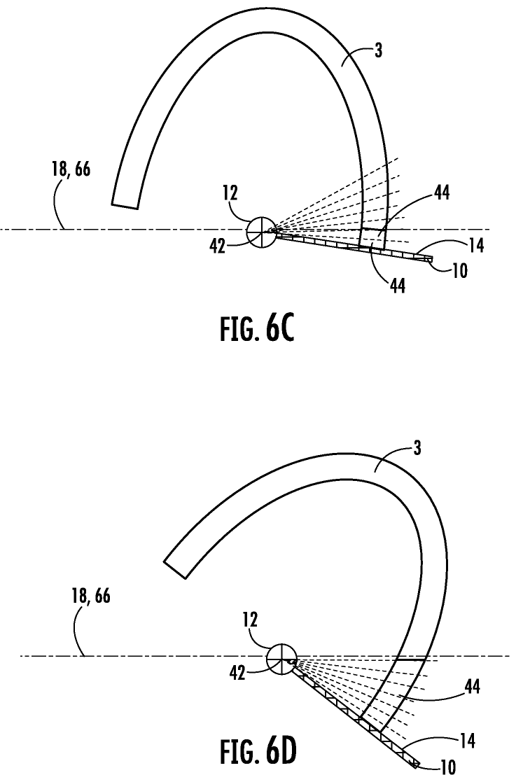

According to 56, the arcuate 3D model 3 is sliced. Slicing is performed with a set of slicing planes that diverge from an axis or an axial region below an apex or upper portion of the arcuate 3D model 3. An example of such slicing is depicted in FIG. 6A. In the illustrated embodiment arcuate 3D article 3 is sliced using a plurality of slicing planes 62 that all extend from the axis of rotation 42 of the axle 12. The first slicing plane 64 extends at an oblique angle relative to the horizontal X-axis. The axis of rotation 42 is located directly below an apex of the arcuate 3D article 3. The result is a set of slices 44 that form the arcuate 3D article 3.

According to 58, the slices 44 are rotated so that they individually have an upper face 46 (FIG. 4B) that is horizontal and can be coincident with the build plane 18. Steps 56 and 58 are put together because they can occur simultaneously or reordered—for example, the slicing can be performed after the 3D article 3 is rotated so that the individual slices 44 have a horizontal upper face 46 upon slicing.

Once steps 56 and 58 are complete, the result is a set of slices 44 for generating the arcuate 3D article 3 using the 3D printing system 2. There may be a delay between these steps and the physical fabrication in step 60. According to step 60, the 3D printing system 2 is operated to form the physical arcuate 3D article 3. Step 60 of method 50 is similar or equivalent to method 30 of FIG. 3, which describes the actual formation. Thus, step 60 is a repeated series of steps.

FIGS. 6B-6D illustrate selective curing of slices to form the 3D article 3. According to 6B, the first slice 44 is formed. This is accomplished by rotating the upper surface of build plate 14 under the upper surface 66 of the photocurable liquid 6 (FIG. 1). The light engine 16 is then activated to selectively irradiate build plane 18 and to harden the first slice 44 of the 3D article 3.

FIG. 6C is similar to FIG. 6B, except that a second slice 68 is formed over the first slice 44. The upper face of the first slice 44 is rotated until it is one slice thickness below the upper surface 66 of the photocurable liquid. Then the light engine 16 is activated to selectively irradiate build plane 18 to harden and accrete the second slice 44 onto the first slice 44. FIG. 6D illustrates seven slices that have been formed over the build plate 10 and each other. This process continues until the entire arcuate article 3 is fabricated. As indicated earlier, “deep dip” motion can be employed to facilitate forming a new layer of uncured photocurable liquid 6 over an upper face 46.

As a note, the slices 44 depicted In FIGS. 6A-D have an exaggerated thickness for illustrative purposes. In practice, the slices can vary in thickness from 20 to 200 microns thick or from 30 to 100 microns thick. In an illustrative embodiment, the slices are about 50 microns thick, but varying in thickness-increasing radially from the axis of rotation 42.

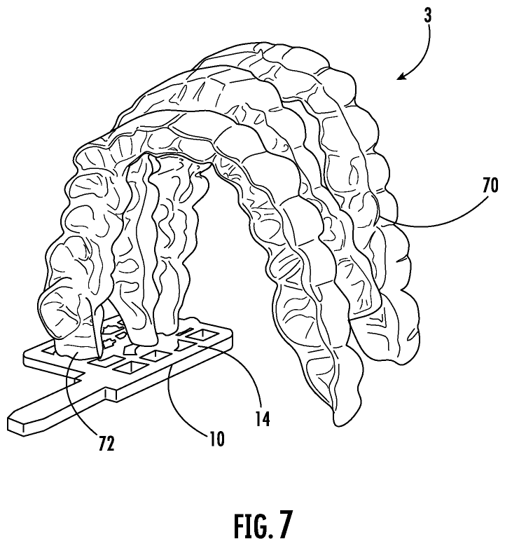

FIG. 7 depicts a single build plate 10 that supports three arcuate 3D articles 3. The illustrated arcuate 3D articles 3 include dental arches 70. Part of the arcuate 3D article 3 is a support structure 72 that serves as a physical interface between the dental arch 70 and the upper surface 14 of the build plate 10.

In the illustrated embodiments, the arcuate 3D article 3 is roughly symmetrical and the axis of rotation 42 is laterally in alignment with the apex of the arcuate 3D article 3 while being in vertical alignment with bases of the arcuate 3D article 3 (at the start of the build). However, variations are possible. For example, the axis of rotation can be placed above or below the bases of the arcuate 3D article 3 or out of lateral alignment with the apex of the arcuate 3D article 3. Also, the arcuate 3D article can be asymmetrical or somewhat irregular in shape. Thus, the specific diagrams are shown for illustrative purposes but are not intended to be limiting.

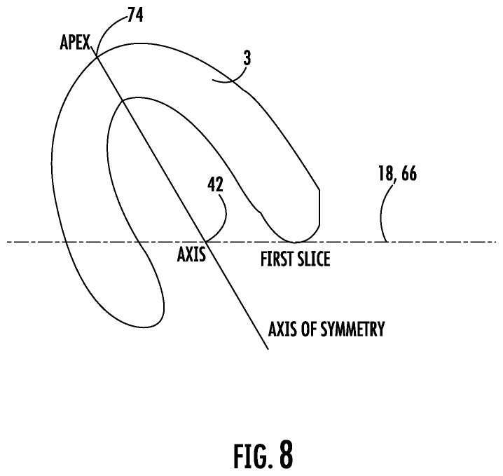

FIG. 8 is a schematic diagram illustrating another embodiment of an arcuate 3D article or dental arch 3 relative to an axis of rotation 42. In this embodiment, axis of rotation 42 is in alignment with an apex 74 along an oblique plane. A build process starts with an axis of symmetry of the dental arch 3 defining an oblique angle with the build plane 18 and top surface 66 of the photocurable liquid 6.

The specific embodiments and applications thereof described above are for illustrative purposes only and do not preclude modifications and variations encompassed by the scope of the following claims.

What is claimed:

1. A three-dimensional (3D) printing system configured to manufacture a plurality of arcuate 3D articles comprising:
a build vessel configured to contain a photocurable liquid having an upper surface;
at least one build assembly individually including:
an axle having a horizontal axis of rotation X;
a build plate attached to the axle extending radially from the axle and having an upper surface; and
a rotational movement mechanism coupled to the axle configured to rotationally position the axle about the axis of rotation X;
a light engine above the build vessel; and
a controller configured to:
operate the rotational movement mechanism to incrementally rotate the build plate about the axis of rotation between a plurality of stop positions; and
operate the light engine at individual stop positions of the plurality of stop positions to selectively irradiate the photocurable liquid within a plurality of spatially separated build planes that are above the build plate to selectively harden a slice of a arcuate 3D article of the plurality of arcuate 3D articles.

2. The 3D printing system of claim 1 wherein the at least one build assembly includes a plurality of the build assemblies arranged along a lateral axis Y that is perpendicular to the axis of rotation X.

3. The 3D printing system of claim 1 wherein the build plate includes a plurality of build plates spaced apart along the axis of rotation X.

4. The 3D printing system of claim 1 wherein the build plate extends along a radial axis r from the axis of rotation X, individual slices of the arcuate 3D article have a thickness that is proportional to r.

5. The 3D printing system of claim 1 wherein the build plate extends along a radial axis r from the axis of rotation X, individual slices of the arcuate 3D article have a trapezoidal cross section having two parallel bases having a base dimensions proportional to their radial positions.

6. The 3D printing system of claim 1 wherein the rotational movement mechanism includes a motorized gear assembly.

7. The 3D printing system of claim 1 wherein the rotational movement mechanism includes a stepper motor coupled to a series of gears configured for a gear reduction between the stepper motor and the axle.

8. The 3D printing system of claim 1 wherein the plurality of arcuate 3D articles includes a plurality of custom dental arches.

9. A method of fabricating a plurality of arcuate 3D articles using the 3D printing system of claim 1 including:
rotatively positioning the build plate having an upper face of a arcuate 3D article a layer thickness below the upper surface of the photocurable liquid; and
operating the light engine to selectively irradiate a plurality of spatially separated build planes individually aligned with the upper face of the arcuate 3D article to cure and harden a slice of the photocurable liquid onto the upper face of the arcuate 3D article.

10. The method of claim 9 wherein the slice of the photocurable liquid has a variable thickness that is proportional to a distance from the axis of rotation X.

11. The method of claim 9 wherein rotationally positioning the build plate rotational positioning includes a deep dip movement in which the build plate rotates move than a layer thickness below the upper surface of the photocurable liquid before rotating to the position with the upper face of a arcuate 3D article a layer thickness below the upper surface of the photocurable liquid.

12. A method of manufacturing an arcuate three-dimensional (3D) article comprising:
providing a 3D solid model of the arcuate 3D article;
slicing the 3D solid model with a set of slicing planes that diverge from an axial region below the arcuate 3D model;
rotatively moving an upper face of a build plate or a partially finished portion of the arcuate article about the locus and provide a layer of photocurable liquid above the upper face;
operating a light engine to selectively cure the layer of photocurable liquid onto the upper face to form a new upper face; and
repeating the rotatively moving and operating the light engine to complete fabrication of the arcuate article from a series of variable thickness slices, the slices individually have an increasing thickness versus distance from the locus.

13. The method of claim 12 wherein the arcuate 3D article includes a dental arch.

14. The method of claim 13 wherein the arcuate 3D article includes a support structure configured to couple one end of the dental arch to the upper face of the build plate.

15. The method of claim 12 wherein the slicing planes diverge from an axis located below the apex of the arcuate 3D model.

16. The method of claim 15 wherein the axis is an axis of rotation of the build plate.

17. The method of claim 15 wherein slicing the 3D model includes forming a stack of slices that have a thickness proportional to a radial distance from the axis.

18. The method of claim 12 wherein the slicing planes diverge from an axis of rotation of the build plate.

19. The method of claim 12 wherein rotatively moving the upper face includes rotating the build plate about an axle having a fixed axis of rotation.

20. A method of manufacturing a plurality of arcuate three-dimensional articles comprising:
(1) providing a 3D printing system including:
a build vessel configured to contain a photocurable liquid having an upper surface;
a build assembly individually including:
an axle having a horizontal axis of rotation X;
a build plate attached to the axle extending radially from the axle and having an upper surface; and
a rotational movement mechanism coupled to the axle configured to rotationally position the axle about the axis of rotation X;
a light engine above the build vessel;
(2) operating the rotational movement mechanism to position an upper face of individual ones of the plurality of arcuate 3D articles to a position that is a layer thickness below the upper surface of the photocurable liquid, the layer thickness varying linearly along a radius extending from an axis of rotation of the axle;
(3) operating the light engine to selectively irradiate a plurality of build planes corresponding individually to the plurality of arcuate three-dimensional (3D) articles and hardening a trapezoidal slice of the photocurable liquid upon the upper face; and
(4) repeating (2) and (3) to complete fabrication of the plurality of arcuate three-dimensional articles.
